(19) United States
(12) Patent Application Publication
(10) Pub. No.: US 2017/0121192 A1
(43) Pub. Date: May 4, 2017

(54) Magnetic Water Treatment Equipment

(71) Applicant: Chien-Hua Wang, Huwei Township (TW)

(72) Inventor: Chien-Hua Wang, Huwei Township (TW)

(21) Appl. No.: 14/925,323

(22) Filed: Oct. 28, 2015

(51) Int. Cl. C02F 1/48

(52) U.S. Cl. CPC C02F 1/48; C02F 2307/06; C02F 2201/48

(57) ABSTRACT

Magnetic water treatment equipment contains: a magnetic water unit. The magnetic water unit includes a circular loop made of rubber material, the circular loop has an inner fence connected with plural magnetization seats, wherein each of the plural magnetization seats is made of rubber material, any two opposite magnetization seats face to each other, and said each magnetization seat has an open receiving room extending inwardly from one end thereof. The magnetic water unit further includes a plurality of magnetic blocks, and each of the plurality of magnetic blocks is accommodated in the receiving room of said each magnetization seat, such that a magnetic field produces among the plural magnetization seats.

### BACKGROUND OF THE INVENTION

Field of the Invention

The present invention relates to magnetic water treatment equipment which magnetizes, resonances, and activates water so that the water is absorbed by human body easily.

Description of the Prior Art

A conventional water treatment contains cartridge filtration, distillation, reverse osmosis, electric ion treatment, and magnetization treatment. However, the cartridge filtration only filters impurities in water, and the distillation and the reverse osmosis are similar to the cartridge filtration, i.e., filtering impurities in water. In electric ion treatment, molecules in the water are pressurized by high voltage to ionize the water, thus obtaining the water with alkaline. But energy of the molecules in the water cannot be enhanced.

The present invention has arisen to mitigate and/or obviate the afore-described disadvantages.

### SUMMARY OF THE INVENTION

The primary objective of the present invention is to provide magnetic water treatment equipment which magnetizes, resonances, and activates water so that the water is absorbed by human body easily.

To obtain above-mentioned objective, magnetic water treatment equipment provided by the present invention contains a magnetic water unit. The magnetic water unit includes a circular loop made of rubber material, the circular loop has an inner fence connected with plural magnetization seats, wherein each of the plural magnetization seats is made of rubber material, any two opposite magnetization seats face to each other, and said each magnetization seat has an open receiving room extending inwardly from one end thereof. The magnetic water unit further includes a plurality of magnetic blocks, and each of the plurality of magnetic blocks is accommodated in the receiving room of said each magnetization seat, such that a magnetic field produces among the plural magnetization seats.

Preferably, the magnetic water unit is housed in the storage cylinder, and the storage cylinder has an accommodation chamber defined therein, an outlet formed on a bottom of the accommodation chamber, and a stepped stop face arranged on a top of the accommodation chamber opposite to the outlet; a protective cover is mounted on the top of the accommodation chamber so that the circular loop of the magnetic water unit is accommodated behind the stepped stop face, and the protective cover includes an inlet in which inner threads are configured, and wherein each of the outlet of the storage cylinder and of the inlet has a filter disposed at a predetermined position thereof.

Preferably, the inner threads of the protective cover are configured to screw with outer threads of an outlet segment on a distal end of a faucet, such that the protective cover mates with outlet segments of different sizes of the faucet and is replaced.

Preferably, the magnetic water unit is housed in a connector, and the connector has an intermediate part in which a cavity is defined, the connector also has two extending parts, wherein each extending part extends outwardly from each of two ends of the intermediate part and has a flange arranged thereon so as to connect with a coupling assembly by ways of plural coupling elements, and the coupling assembly has a tubular member coupled on a distal end thereof, each of said each end of the intermediate part and of a distal end of said each extending part has a filter configured to fix the magnetic water unit in the cavity of the connector of the intermediate part.

Preferably, a magnetic water unit is housed in a connector, and the connector has an intermediate part and two extending parts, wherein each extending part extends outwardly from each of two ends of the intermediate part, and the intermediate part has a cavity defined therein, said each extending part has a flange arranged thereon so as to connect with a coupling assembly by ways of plural coupling elements, and the coupling assembly has a tubular member coupled on a distal end thereof, wherein each of said each end of the intermediate part and of a distal end of said each extending part has a filter configured thereon, such that the magnetic water unit is fixed on an inner wall of the intermediate part of the connector, wherein the magnetic water unit includes plural magnetization seats and a plurality of magnetic blocks, each of the plurality of magnetic blocks is accommodated in each magnetization seat, and the intermediate part has a magnetic filtration unit mounted therein.

Thereby, the water flows through the magnetic water unit so as to rotate its molecules by using the magnetic coil in the magnetic field, and its macromolecular group is cut into the micro molecule groups, hence the water has interface activity, permeability, and dissociative, and it is magnetized, resonance, and activated so as to replace dish soap, shower gel, and shampoo for cleaning oily substances on human body, fruits or vegetables. Preferably, the water is used as irrigation source in agriculture and fishery industries and is absorbed by human body easily, after being drunk.

### BRIEF DESCRIPTION OF THE DRAWINGS

FIG. 1 is a cross-sectional perspective view showing the assembly of a part of magnetic water treatment equipment according to a first embodiment of the present invention.

FIG. 2 is a perspective view showing the exploded components of a magnetic water unit of the magnetic water treatment equipment according to the first embodiment of the present invention.

FIG. 3 is a cross sectional view showing the application of the magnetic water treatment equipment according to the first embodiment of the present invention.

FIG. 4 is another cross sectional view showing the application of the magnetic water treatment equipment according to the first embodiment of the present invention.

FIG. 5 is a cross-sectional perspective view showing the assembly of a part of magnetic water treatment equipment according to a second embodiment of the present invention

FIG. 6 is a cross sectional view showing the application of the magnetic water treatment equipment according to the second embodiment of the present invention.

FIG. 7 is a cross sectional view showing the application of the magnetic water treatment equipment according to a third embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

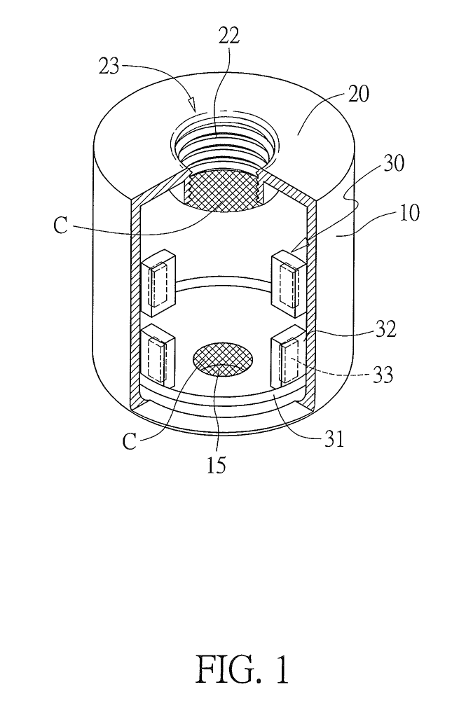

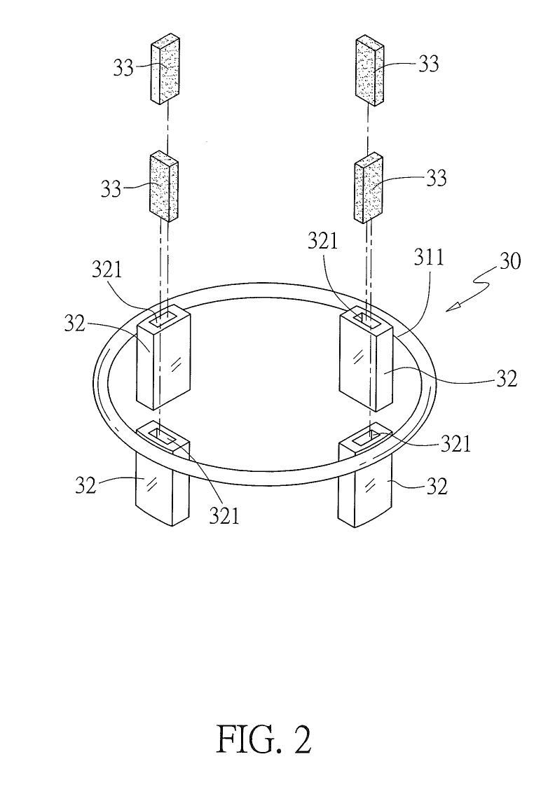

With reference to FIGS. 1 to 4, magnetic water treatment equipment according to a first embodiment of the present invention comprises: a storage cylinder 10, a protective cover 20, and a magnetic water unit 30.

The storage cylinder 10 includes an accommodation chamber 13 defined therein, an outlet 15 formed on a bottom of the accommodation chamber 13, a stepped stop face 14 arranged on a top of the accommodation chamber 13 opposite to the outlet 15.

The protective cover 20 is mounted on the top of the accommodation chamber 13 and includes an inlet 23 in which inner threads 22 are configured to screw with outer threads of an outlet segment 2 on a distal end of a faucet 1, such that the protective cover 20 mates with outlet segments 2 of different sizes of the faucet 1 and is replaced based on using requirements, wherein each of the outlet 15 of the storage cylinder 10 and of the inlet 23 has a filter C disposed at a predetermined position thereof.

The magnetic water unit 30 is housed on the stepped stop face 14 of the accommodation chamber 13 of the storage cylinder 10, and the magnetic water unit 30 includes a circular loop 31 made of rubber material, the circular loop 31 has an inner fence 311 connected with plural magnetization seats 32, wherein each of the plural magnetization seats 32 is made of rubber material, any two opposite magnetization seats 32 face to each other, and said each magnetization seat 32 has an open receiving room 321 extending inwardly from one end thereof. The magnetic water unit 30 further includes a plurality of magnetic blocks 33, and each of the plurality of magnetic blocks 33 is accommodated in the receiving room 321 of said each magnetization seat 32, such that a magnetic field produces among the plural magnetization seats 32.

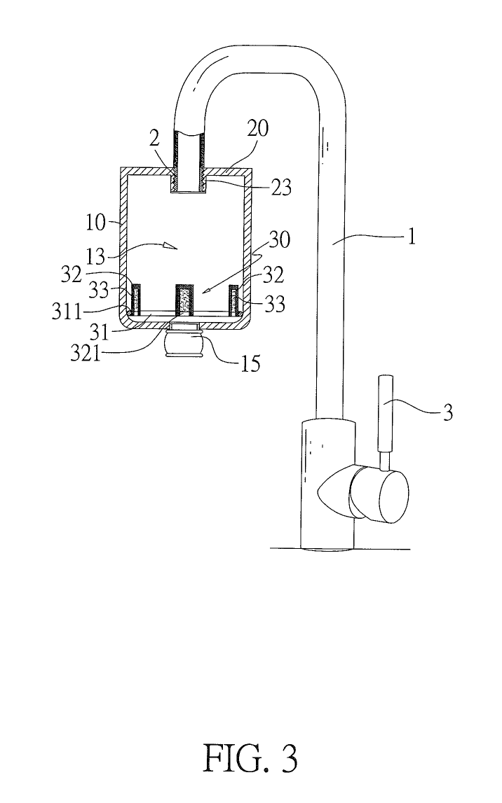

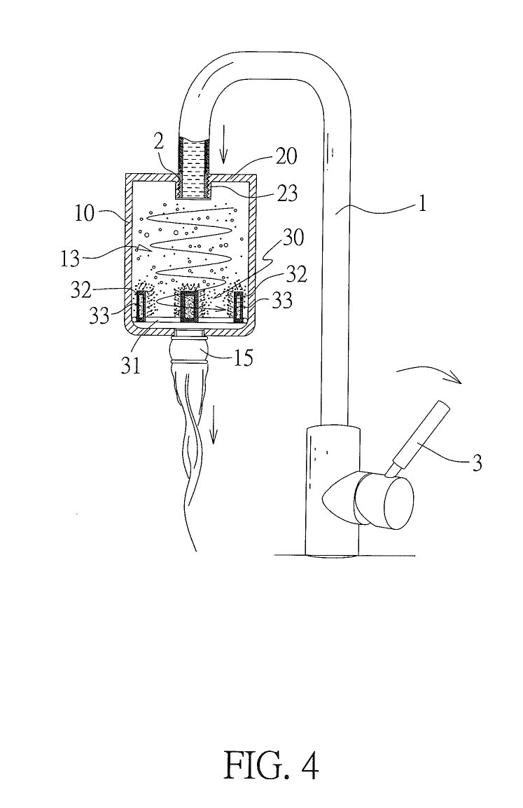

In operation, as shown in FIGS. 3 and 4, water flows into the accommodation chamber 13 from the outlet 2 of the faucet 1 via the inlet 23 of the storage cylinder 10, after turning on a switch lever 3 of the faucet 1, and the water rotates by using a magnetic coil in the magnetic field among the plural magnetization seats 32, hence a macromolecular group of the water is cut into micro molecule groups so that the water is absorbed by human body easily after being magnetized, resonance, and activated.

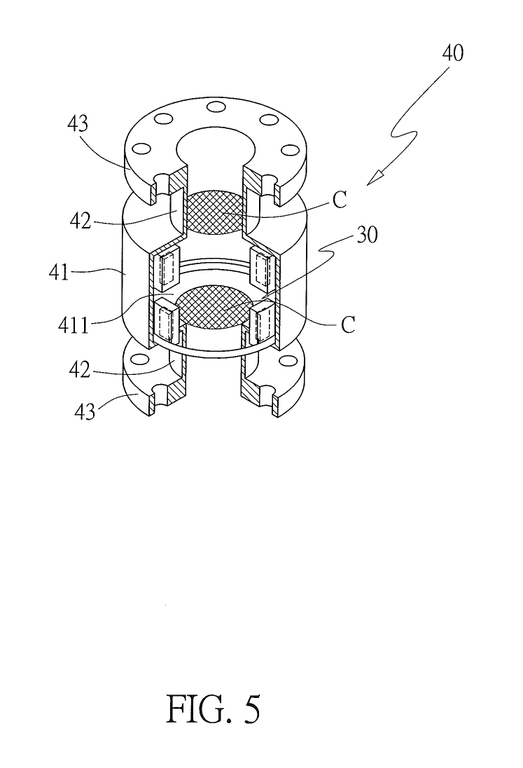

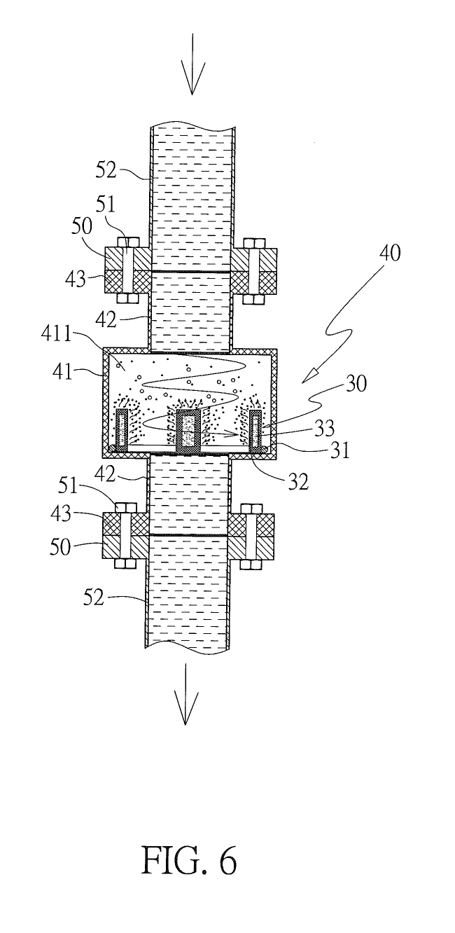

Referring to FIGS. 5 and 6, a difference of magnetic water treatment equipment of a second embodiment of the present invention from that of the first embodiment comprises: a magnetic water unit 30 housed in a connector 40, wherein the connector 40 has an intermediate part 41 in which a cavity 411 is defined, and the connector 40 also has two extending parts 42, wherein each extending part 42 extends outwardly from each of two ends of the intermediate part 41 and has a flange 43 arranged thereon so as to connect with a coupling assembly 50 by ways of plural coupling elements 51, and the coupling assembly 50 has a tubular member 52 coupled on a distal end thereof. In addition, each of said each end of the intermediate part 41 and of a distal end of said each extending part 42 has a filter C configured to fix the magnetic water unit 30 in the cavity 411 of the connector 40 of the intermediate part 41.

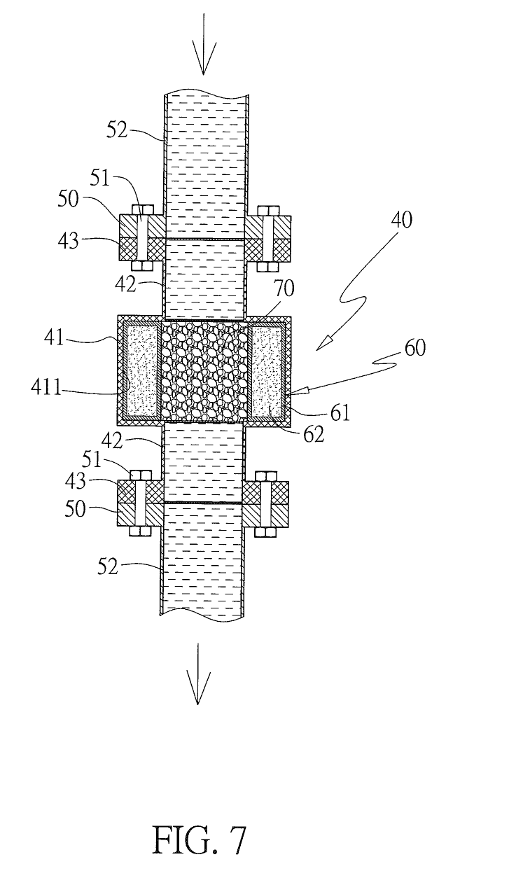

As illustrated in FIG. 7, a difference of magnetic water treatment equipment of a third embodiment of the present invention from that of the first embodiment comprises: a magnetic water unit 60 housed in a connector 40, wherein the connector 40 has an intermediate part 41 and two extending parts 42, wherein each extending part 42 extends outwardly from each of two ends of the intermediate part 41, and the intermediate part 41 has a cavity 411 defined therein. Said each extending part 42 has a flange 43 arranged thereon so as to connect with a coupling assembly 50 by ways of plural coupling elements 51, and the coupling assembly 50 has a tubular member 52 coupled on a distal end thereof. In addition, each of said each end of the intermediate part 41 and of a distal end of said each extending part 42 has a filter C configured thereon, such that the magnetic water unit 60 is fixed on an inner wall of the intermediate part 41 of the connector 40, wherein the magnetic water unit 60 includes plural magnetization seats 61 and a plurality of magnetic blocks 62, each of the plurality of magnetic blocks 62 is accommodated in each magnetization seat 61, and the intermediate part 41 has a magnetic filtration unit 70 mounted therein.

Thereby, the water flows through the magnetic water unit so as to rotate its molecules by using the magnetic coil in the magnetic field, and its macromolecular group is cut into the micro molecule groups, hence the water has interface activity, permeability, and dissociative, and it is magnetized, resonance, and activated so as to replace dish soap, shower gel, and shampoo for cleaning oily substances on human body, fruits or vegetables. Preferably, the water is used as irrigation source in agriculture and fishery industries and is absorbed by human body easily, after being drunk.

While we have shown and described various embodiments in accordance with the present invention, it is clear to those skilled in the art that further embodiments may be made without departing from the scope of the present invention.

What is claimed is:

1. Magnetic water treatment equipment comprising:
a magnetic water unit including a circular loop made of rubber material, the circular loop having an inner fence connected with plural magnetization seats, wherein each of the plural magnetization seats is made of rubber material, any two opposite magnetization seats face to each other, and said each magnetization seat has an open receiving room extending inwardly from one end thereof;
the magnetic water unit further including a plurality of magnetic blocks, and each of the plurality of magnetic blocks being accommodated in the receiving room of said each magnetization seat, such that a magnetic field produces among the plural magnetization seats.

2. The magnetic water treatment equipment as claimed in claim 1, wherein the magnetic water unit is housed in the storage cylinder, and the storage cylinder has an accommodation chamber defined therein, an outlet formed on a bottom of the accommodation chamber, and a stepped stop face arranged on a top of the accommodation chamber opposite to the outlet; a protective cover is mounted on the top of the accommodation chamber so that the circular loop of the magnetic water unit is accommodated behind the stepped stop face, and the protective cover includes an inlet in which inner threads are configured, and wherein each of the outlet of the storage cylinder and of the inlet has a filter disposed at a predetermined position thereof.

3. The magnetic water treatment equipment as claimed in claim 2, wherein the inner threads of the protective cover are configured to screw with outer threads of an outlet segment on a distal end of a faucet, such that the protective cover mates with outlet segments of different sizes of the faucet and is replaced.

4. The magnetic water treatment equipment as claimed in claim 1, wherein the magnetic water unit is housed in a connector, and the connector has an intermediate part in which a cavity is defined, the connector also has two extending parts, wherein each extending part extends outwardly from each of two ends of the intermediate part and has a flange arranged thereon so as to connect with a coupling assembly by ways of plural coupling elements, and the coupling assembly has a tubular member coupled on a distal end thereof, each of said each end of the intermediate part and of a distal end of said each extending part has a filter configured to fix the magnetic water unit in the cavity of the connector of the intermediate part.

5. The magnetic water treatment equipment as claimed in claim 1, wherein a magnetic water unit is housed in a connector, and the connector has an intermediate part and two extending parts, wherein each extending part extends outwardly from each of two ends of the intermediate part, and the intermediate part has a cavity defined therein, said each extending part has a flange arranged thereon so as to connect with a coupling assembly by ways of plural coupling elements, and the coupling assembly has a tubular member coupled on a distal end thereof, wherein each of said each end of the intermediate part and of a distal end of said each extending part has a filter configured thereon, such that the magnetic water unit is fixed on an inner wall of the intermediate part of the connector, wherein the magnetic water unit includes plural magnetization seats and a plurality of magnetic blocks, each of the plurality of magnetic blocks is accommodated in each magnetization seat, and the intermediate part has a magnetic filtration unit mounted therein.
